(19) United States
(12) Patent Application Publication
(10) Pub. No.: US 2015/0242058 A1
(43) Pub. Date: Aug. 27, 2015

(54) TOUCH SENSING DEVICE AND TOUCH SENSING METHOD

(71) Applicant: Samsung Electro-Mechanics Co., Ltd., Suwon (KR)

(72) Inventors: Jong In NA, Suwon (KR); Ji Hoon KIM, Suwon (KR)

(73) Assignee: Samsung Electro-Mechanics Co., Ltd., Suwon (KR)

(21) Appl. No.: 14/296,848

(22) Filed: Jun. 5, 2014

(30) Foreign Application Priority Data
Feb. 24, 2014 (KR) 10-2014-0021102

(51) Int. Cl. G06F 3/043; G06F 3/041

(52) U.S. Cl. CPC G06F 3/0433; G06F 3/0416; G06F 2203/04101

(57) ABSTRACT

A touch sensing device may include: a window glass unit receiving at least one of a touch and a hover, a driving unit vibrating the window glass unit, a sensing unit measuring displacement information of the window glass unit and a controlling unit determining whether the window glass unit has received the touch or the hover by comparing the displacement information of the window glass unit with a preset value.

### CROSS-REFERENCE TO RELATED APPLICATION

This application claims the benefit of Korean Patent Application No. 10-2014-0021102 filed on Feb. 24, 2014, with the Korean Intellectual Property Office, the disclosure of which is incorporated herein by reference.

### BACKGROUND

The present disclosure relates to a touch sensing device and a touch sensing method.

Since a touch sensing device, a user interface, is relatively intuitive and is easy to use, it has been developed as a main input device. Particularly, since capacitive type touch sensing devices have excellent touch sensitivity and enable multi-touch inputs, most touch sensing devices are capacitive type devices.

Meanwhile, as mobile phone functionality has gradually been diversified, methods of using mobile phones have become increasingly complicated. Accordingly, various user interfaces enabling users to more easily access various device functions have been developed. However, a method of using a touch may only allow a function to be selected when a menu or an icon displayed on a screen is touched by a finger. Thus, it does not allow for various input methods according to user gestures.

Recently, in order to address this problem, a product sensing a hover event has been released. In this case, referring to FIG. 1A, “hover” refers to a case in which the finger is close to a touch panel, but not in actual contact therewith, namely, a proximity touch. In addition, “hovering” refers to a technology in which a contact point on a mobile device is viewed in advance by emulating ‘mouse over,’ an operation well known in the field of personal computing for performing web navigation to allow the user to accurately select a target click location.

Referring to FIG. 1B, in the case in which a user wears gloves, when a gloved user finger contacts a touch panel, it should be recognized as a touch. However, because the user's finger is not in direct contact with the touch panel, it may be recognized as a hover.

Patent Document 1 relates to an information processing device and discloses that a user is able to use a touch screen as if with bare hands even in the case in which the user is wearing gloves. However, unlike the present disclosure, Patent Document 1 fails to disclose the features of vibrating a window glass unit to sense displacement information and determining whether the window glass unit has received a touch or a hover.

### RELATED ART DOCUMENT

(Patent Document 1) Japanese Patent Laid-Open Publication No. 2012-133729

### SUMMARY

An aspect of the present disclosure may provide a touch sensing device and a touch sensing method capable of determining whether a window glass unit receives a touch or a hover by vibrating the window glass unit to sense displacement information thereof.

According to an aspect of the present disclosure, a touch sensing device may include: a window glass unit receiving at least one of a touch and a hover; a driving unit vibrating the window glass unit; a sensing unit measuring displacement information of the window glass unit; and a controlling unit determining whether the window glass unit has received the touch or the hover by comparing the displacement information of the window glass unit with a preset value.

The driving unit may include: a driving piezo element mounted on the window glass unit to generate vibrations; and a piezo-driving unit providing a driving frequency having a preset frequency range to the driving piezo element.

The driving piezo element may be mounted on at least one of upper, lower, leftward, and rightward surfaces of the window glass unit, based on a center point of the window glass unit.

The controlling unit may determine that the window glass unit has received the touch when the displacement information measured by the sensing unit is less than the preset value, and may determine that the window glass unit has received the hover when the displacement information measured by the sensing unit is equal to or greater than the preset value.

The controlling unit may include: a memory unit storing the preset value; a comparing unit comparing the displacement information with the preset value; and a determining unit determining whether the window glass unit has received the touch or the hover, depending on a comparison result.

The sensing unit may include: a sensing piezo element sensing vibrations generated from the window glass unit; and a displacement sensing unit sensing displacement of the sensing piezo element.

The sensing piezo element may be mounted on at least one of upper, lower, left, and right surfaces of the window glass unit, based on a center point of the window glass unit.

The touch sensing device may further include a touch panel disposed between the driving unit and the sensing unit.

According to another aspect of the present disclosure, a touch sensing method may include: vibrating, by a driving unit, a window glass unit; receiving, by the window glass unit, at least one of a touch and a hover; measuring, by a sensing unit, displacement information of the window glass unit; and determining whether the window glass unit has received the touch or the hover by comparing the measured displacement information with a preset value.

The determining of whether the window glass unit has received the touch or the hover may include: comparing the measured displacement information with the preset value; and determining that the window glass unit has received the touch when the measured displacement information is less than the preset value, and determining that the window glass unit has received the hover when the measured displacement information is equal to or greater than the preset value.

The driving unit may include: a driving piezo element mounted on the window glass unit to generate vibrations; and a piezo-driving unit providing a driving frequency having a preset frequency range to the driving piezo element.

The driving piezo element may be mounted on at least one of upper, lower, left, and right surfaces of the window glass unit, based on a center point of the window glass unit.

The sensing unit may include: a sensing piezo element sensing vibrations generated from the window glass unit; and a displacement sensing unit sensing displacement of the sensing piezo element.

The sensing piezo element may be mounted on at least one of upper, lower, left, and right surfaces of the window glass unit, based on a center point of the window glass unit.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1A and 1B are diagrams illustrating a distinction between a hover (a) and a touch (b) in a touch sensing device according to the related art;

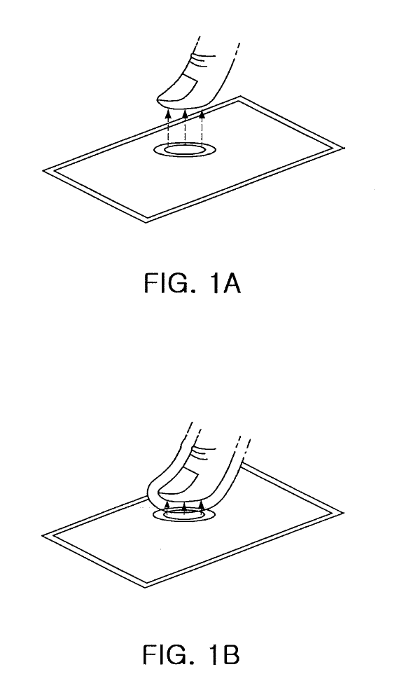

FIG. 2 is a perspective view illustrating an exterior appearance of an electronic device including a touch sensing device according to an exemplary embodiment of the present disclosure;

FIG. 3 is a block diagram illustrating a touch sensing device according to an exemplary embodiment of the present disclosure;

FIG. 4 is a block diagram illustrating the configuration of a controlling unit in the touch sensing device of FIG. 3;

FIG. 5 is a block diagram illustrating the touch sensing device of FIG. 3 in more detail;

FIG. 6 is a diagram illustrating an operation of a touch sensing device according to an exemplary embodiment of the present disclosure; and

FIG. 7 is a flowchart illustrating a touch sensing method according to another exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same reference numerals will be used to designate the same or like elements.

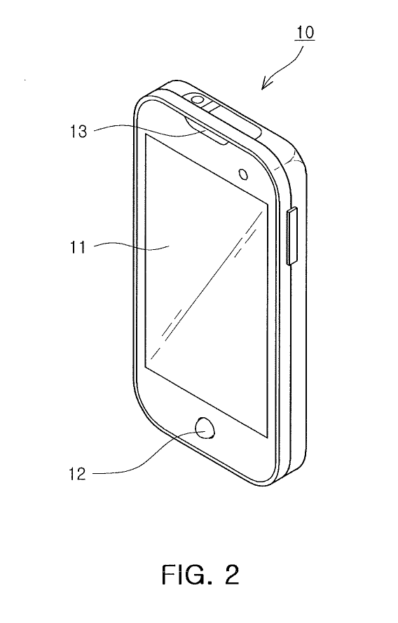

FIG. 2 is a perspective view illustrating an exterior appearance of an electronic device including a touch sensing device according to an exemplary embodiment of the present disclosure. Referring to FIG. 2, the electronic device 10 according to the present exemplary embodiment may include a display device 11 displaying images, an input unit 12, an audio unit 13 for audio output, and a touch screen device integrated with the display device 11.

As shown in FIG. 2, in the case of a mobile device, the touch screen device may be generally provided to be integrated with the display device, and is required to have a degree of light transmissivity sufficient allow an image displayed on the display device to be transmitted therethrough. Therefore, the touch screen device may be obtained by forming sensing electrodes using a transparent and electrically conductive material such as indium tin oxide (ITO), indium zinc oxide (IZO), zinc oxide (ZnO), carbon nano tube (CNT), or graphene, on a base substrate formed of a transparent film material such as polyethylene terephtalate (PET), polycarbonate (PC), polyethersulfone (PES), polyimide (PI), or the like. The display device may include a wiring pattern disposed in a bezel region thereof, in which the wiring pattern is connected to the sensing electrodes formed of the transparent and conductive material. Since the wiring pattern is visually shielded by the bezel region, it may also be formed of a metal material such as silver (Ag), copper (Cu), or the like.

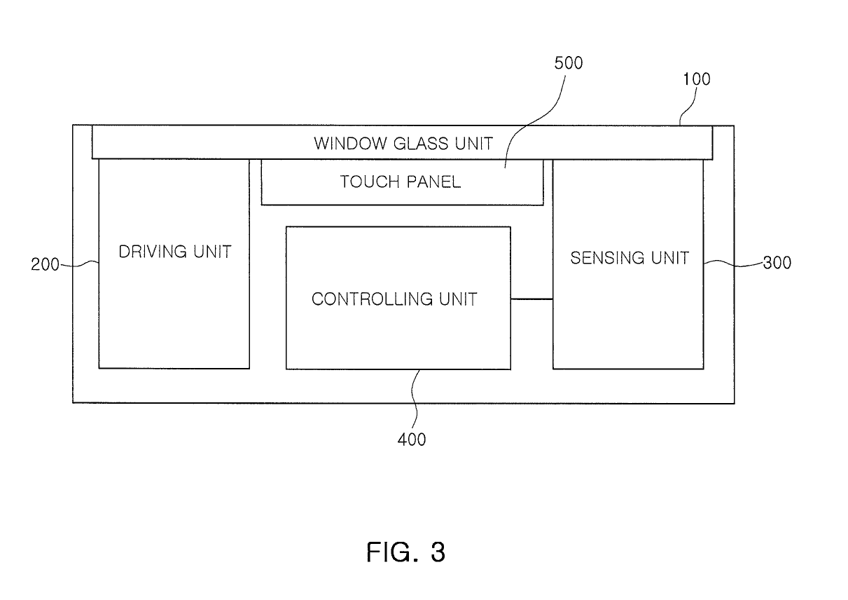

Hereinafter, a touch sensing device according to an exemplary embodiment of the present disclosure will be described with reference to FIGS. 3 through 7.

FIG. 3 is a block diagram illustrating a touch sensing device according to an exemplary embodiment of the present disclosure.

Referring to FIG. 3, a touch sensing device according to an exemplary embodiment of the present disclosure may include a window glass unit 100, a driving unit 200, a sensing unit 300, a controlling unit 400, and a touch panel 500.

The window glass unit 100 may receive at least one of a touch and a hover from a user.

The driving unit 200 may be located at a lower end of the window glass unit 100 and generate vibrations to vibrate the window glass unit 100.

When the window glass unit 100 is vibrated by the driving unit 200, the sensing unit 300 may measure displacement information. That is, the driving unit 200 may vibrate the window glass unit 100 by generating the vibrations according to a preset driving frequency, and the sensing unit 300 may measure the displacement information resulting from the vibrations of the window glass unit 100 to provide the measured displacement information to the controlling unit 400.

The controlling unit 400 may receive the displacement information from the sensing unit 300 and compare it with a preset value to determine whether the window glass unit has received the touch or the hover. Here, the preset value may be displacement information when there is no input to the window glass unit 100.

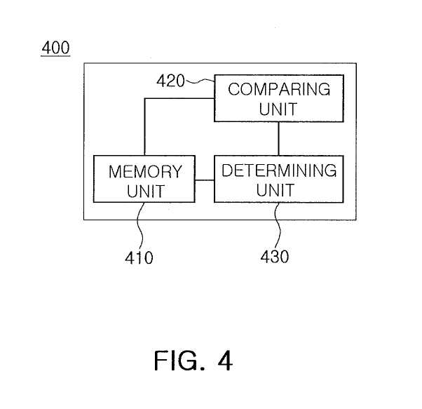

The controlling unit 400 will be described in detail with reference to FIG. 4.

FIG. 4 is a block diagram illustrating the configuration of the controlling unit 400 in the touch sensing device of FIG. 3.

Referring to FIGS. 3 and 4, the controlling unit 400 may include a memory unit 410, a comparing unit 420, and a determining unit 430.

The memory unit 410 may store a preset value to be compared with the displacement information of the window glass unit 100. The comparing unit 420 may compare the displacement information with the preset value stored in the memory unit 410 and provide a comparison result to the determining unit 430.

The determining unit 430 may determine whether the window glass unit has received the touch or the hover, depending on the comparison result of the comparing unit 420. More particularly, the determining unit 430 may determine that the window glass unit has received the touch when the displacement information is less than the preset value, and may determine that the window glass unit has received the hover when the displacement information is equal to or greater than the preset value.

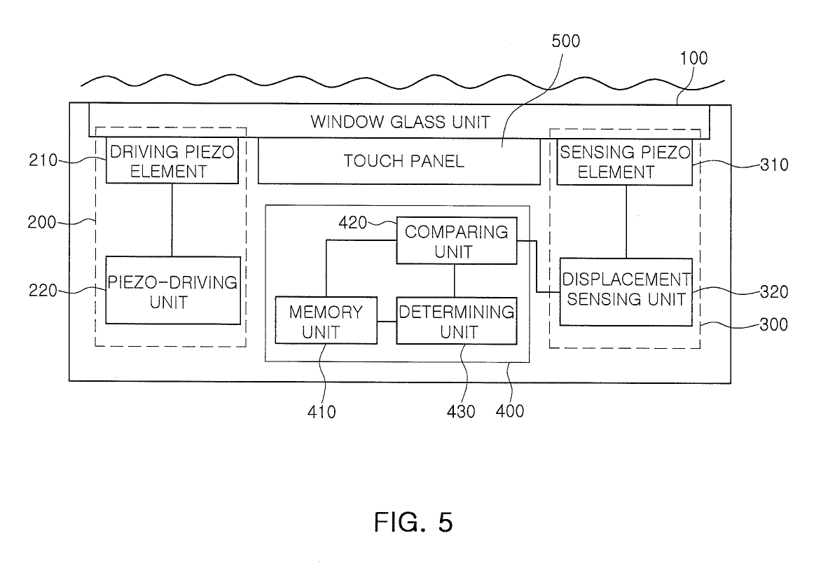

FIG. 5 is a block diagram illustrating the configuration of the touch sensing device of FIG. 3 in more detail.

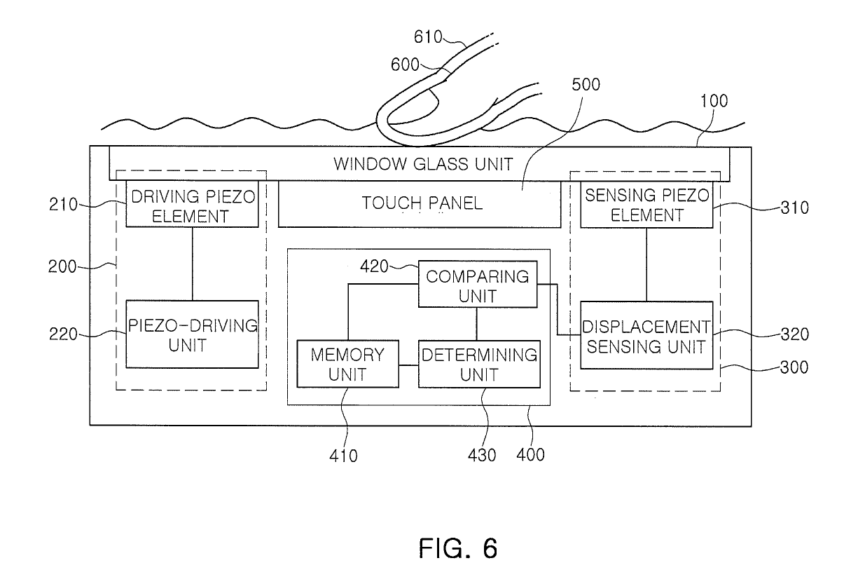

FIG. 6 is a diagram illustrating an operation of the touch sensing device according to an exemplary embodiment of the present disclosure.

A touch sensing device and an operation thereof according to an exemplary embodiment of the present disclosure will be described in detail with reference to FIGS. 5 and 6.

Referring to FIG. 5, the driving unit 200 may include a driving piezo element 210 and a piezo-driving unit 220.

The driving piezo element 210 may be mounted on at least one of upper, lower, left, and right surfaces of the window glass unit 100, based on a center point of the window glass unit 100. In FIG. 5, the driving piezo element 210 is mounted on the lower surface of the window glass unit 100, based on the center point of the window glass unit 100, while being at the left side based on a sensing piezo element 310, by way of example.

The piezo-driving unit 220 may provide a driving frequency having a preset range to the driving piezo element 210. Accordingly, the driving piezo element 210 may generate displacement depending on the driving frequency. Then, the window glass unit 100 may be vertically vibrated due to the vibrations generated by the driving piezo element 210.

Meanwhile, the vibrations from the window glass unit 100 may be sensed by the sensing piezo element 310.

That is, the sensing unit 300 may include the sensing piezo element 310 and a displacement sensing unit 320. The sensing piezo element 310 may be mounted on the lower surface of the window glass unit 100 to sense the vibrations generated from the window glass unit 100. The displacement sensing unit 320 may measure displacement information of the sensing piezo element 310 using the vibrations sensed by the sensing piezo element 310.

Meanwhile, the sensing piezo element 310 may be mounted on at least one of the upper, lower, left, and right surfaces of the window glass unit 100, based on a center point of the window glass unit 100. In FIG. 5, the sensing piezo element 310 is mounted on the lower surface of the window glass unit 100, while being at the right side based on the driving piezo element 210, by way of example.

Next, the displacement information measured by the displacement sensing unit 320 may be provided to the comparing unit 420 of the controlling unit 400. The comparing unit 420 may compare the displacement information with the preset value stored in the memory unit 410 and provide the comparison result to the determining unit 430. The determining unit 430 may determine whether the window glass unit 100 has received the touch or the hover, depending on the comparison result as described above.

Referring to FIG. 6, it may be appreciated that a gloved user finger is spaced apart from the window glass unit 100 by a volume of the glove.

When a user touches the window glass unit 100 in a state of wearing the gloves, it should be recognized as a ‘touch’. However, since the gloved user finger is spaced apart from the window glass unit by the volume of the glove, the user's input may be recognized as a hover.

However, the touch sensing device according to the exemplary embodiment of the present disclosure may accurately recognize the user's input as the touch rather than the hover, even if the user's input is made by the gloved finger.

More particularly, the driving piezo element 210 may generate the vibrations corresponding to the driving frequency received from the piezo-driving unit 220 to vibrate the window glass unit 100. In this case, since the user applies the input to the window glass unit 100 in the state in which the user wears the gloves, the displacement measured by the sensing unit 300 is decreased as compared to the displacement in the case in which there is no input to the window glass unit 100.

Therefore, since a displacement value measured by the sensing unit 300 is smaller than the preset value, the determining unit 430 of the controlling unit 400 may determine that the window glass unit 100 has received the touch.

That is, the touch sensing device according to the exemplary embodiment of the present disclosure may also accurately determine a contact in a state in which the user wears the gloves as a touch rather than a hover.

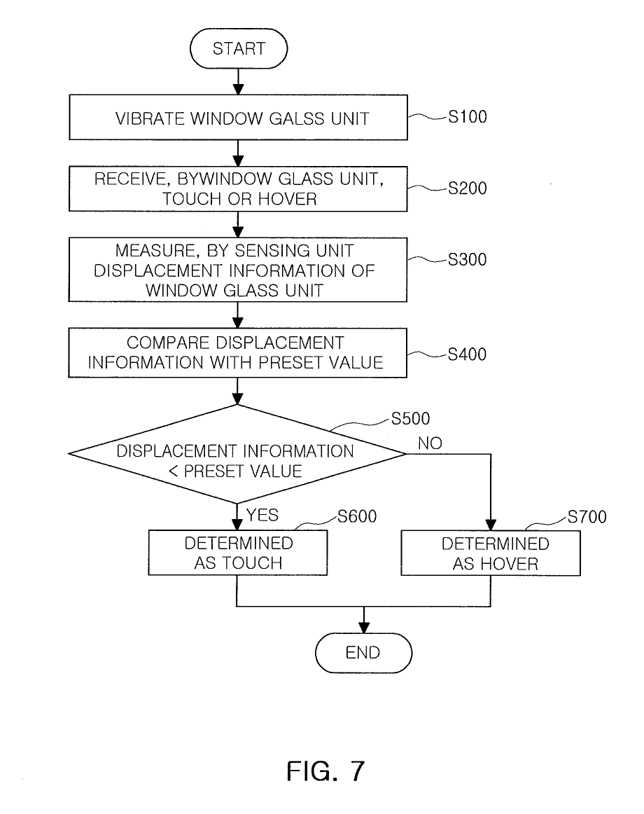

FIG. 7 is a flowchart illustrating a touch sensing method according to another exemplary embodiment of the present disclosure.

Referring to FIGS. 5 and 7, a touch sensing method according to another exemplary embodiment of the present disclosure may include vibrating, by the driving piezo element 210, the window glass unit 100 (S100), receiving, by the window glass unit 100, a touch or a hover from a user (S200), measuring, by the sensing unit 300, displacement information of the window glass unit 100 (S300), comparing, by the controlling unit 400, the measured displacement information with a preset value (S400), and determining whether the displacement information is less than the preset value (S500).

As a result of determination performed by the controlling unit 400, when the displacement information is less than the preset value, the user's input may be determined as the touch (S600), and when the displacement information is equal to or greater than the preset value, the user's input may be determined as the hover (S700).

As set forth above, according to exemplary embodiments of the present disclosure, the touch sensing device and the touch sensing method may accurately recognize a user's input (direct contact) as a touch rather than a hover, even in the case in which the user wears the gloves.

While exemplary embodiments have been shown and described above, it will be apparent to those skilled in the art that modifications and variations could be made without departing from the spirit and scope of the present disclosure as defined by the appended claims.

What is claimed is:

1. A touch sensing device comprising:
a window glass unit receiving at least one of a touch and a hover;
a driving unit vibrating the window glass unit;
a sensing unit measuring displacement information of the window glass unit; and
a controlling unit determining whether the window glass unit has received the touch or the hover based on the displacement information of the window glass unit.

2. The touch sensing device of claim 1, wherein the driving unit includes:
a driving piezo element mounted on the window glass unit to generate vibrations; and
a piezo-driving unit providing a driving frequency having a preset frequency range to the driving piezo element.

3. The touch sensing device of claim 2, wherein the driving piezo element is mounted on at least one of upper, lower, left, and right surfaces of the window glass unit, based on a center point of the window glass unit.

4. The touch sensing device of claim 1, wherein the controlling unit determines that the window glass unit has received the touch when the displacement information measured by the sensing unit is less than a preset value, and determines that the window glass unit has received the hover when the displacement information measured by the sensing unit is equal to or greater than the preset value.

5. The touch sensing device of claim 1, wherein the controlling unit includes:
a memory unit storing a preset value;
a comparing unit comparing the displacement information with the preset value; and
a determining unit determining whether the window glass unit has received the touch or the hover, depending on a comparison result.

6. The touch sensing device of claim 1, wherein the sensing unit includes:
a sensing piezo element sensing vibrations generated from the window glass unit; and
a displacement sensing unit sensing displacement of the sensing piezo element.

7. The touch sensing device of claim 6, wherein the sensing piezo element is mounted on at least one of upper, lower, left, and right surfaces of the window glass unit, based on a center point of the window glass unit.

8. The touch sensing device of claim 1, further comprising a touch panel disposed between the driving unit and the sensing unit.

9. A touch sensing method, comprising:
vibrating a window glass unit;
receiving at least one of a touch and a hover;
measuring displacement information of the window glass unit; and
determining whether the window glass unit has received the touch or the hover by comparing the measured displacement information with a preset value.

10. The touch sensing method of claim 9, wherein the determining of whether the window glass unit has received the touch or the hover includes:
comparing the measured displacement information with the preset value; and
determining that the window glass unit has received the touch when the measured displacement information is less than the preset value, and determining that the window glass unit has received the hover when the measured displacement information is equal to or greater than the preset value.

11. The touch sensing method of claim 9, wherein the driving unit includes:
a driving piezo element mounted on the window glass unit to generate vibrations; and
a piezo-driving unit providing a driving frequency having a preset frequency range to the driving piezo element.

12. The touch sensing method of claim 11, wherein the driving piezo element is mounted on at least one of upper, lower, left, and right surfaces of the window glass unit, based on a center point of the window glass unit.

13. The touch sensing method of claim 9, wherein the sensing unit includes:
a sensing piezo element sensing vibrations generated from the window glass unit; and
a displacement sensing unit sensing displacement of the sensing piezo element.

14. The touch sensing method of claim 13, wherein the sensing piezo element is mounted on at least one of upper, lower, left, and right surfaces of the window glass unit, based on a center point of the window glass unit.
